(19) United States
(12) Patent Application Publication
(10) Pub. No.: US 2003/0140409 A1
(43) Pub. Date: Jul. 31, 2003

(54) Truck mounted urinal system

(76) Inventor: Jesse C. Johnson, Long Beach, CA (US)

Correspondence Address: David A. Belasco, Esq., BEEHLER & PAVITT, Suite 330, 100 Corporate Pointe, Culver City, CA, 90230, US

(21) Appl. No.: 10/058,184

(22) Filed: Jan. 25, 2002

(51) Int. Cl. B60R 15/04

(52) U.S. Cl. 4/458

(57) ABSTRACT

A truck mounted urinal system that includes a reservoir that is emptied with a minimum of leakage includes a urine receptacle having a sealable lid. The receptacle is attached at its outlet opening to a transfer hose that connects to the reservoir. The outlet opening includes a push-pull activated shutoff valve to control fumes. The transfer hose is removably sealed to the inlet opening of the reservoir with a compression nut and includes a shutoff valve. The inlet opening of the reservoir is dimensioned so that when the shutoff valve is closed and the transfer hose withdrawn, any urine left in the hose below the shutoff valve will be contained within the inlet opening, thus preventing leakage. An emptying port with cap is provided that includes opening at the base of the port for urine to return to the reservoir that may have collected on the port or the cap.

### FIELD OF INVENTION

The invention pertains to urine receptacles and containment systems. More particularly, the invention relates to a truck mounted urinal system design for the needs of long-haul truckers.

### BACKGROUND OF THE INVENTION

Truckers traversing long distances on our nation's highways are often faced with long stretches of roadway along which few public restrooms are available. The resulting discomfort is both unhealthy and dangerous to the trucker and others on the road. Even when such facilities are available, tight schedules and the necessary delays involved in using these facilities make an alternate solution desirable for the trucker. Various devices have been developed to provide the trucker the ability to relieve himself or herself without having to stop at the available public restrooms.

U.S. Pat. No. 5,285,532 issued to Sealy is directed to an improved portable urinal device that consists of a structure for holding urine and a mechanism for channeling the flow of urine discharged from a body of a person. An apparatus is provided for suspending the urine channeling mechanism above the urine holding structure. A conduit connects the urine channeling mechanism to the urine holding structure, so that the urine discharged from the body of the person can go directly into the urine holding structure.

U.S. Pat. No. 5,551,097 issued to Short, discloses a sanitary, compact urinal system that can be used in confined spaces such as in trucks, boats, planes, and the like. The system includes a flushing tank for storing a flushing fluid and a remote receptacle head for receiving urine from a user. A pump, which is actuated by a switch mounted on the receptacle head, pumps flushing fluid through a flushing line from the flushing tank into the receptacle head. A waste line drains urine and flushing fluid from the receptacle head into a waste tank, which may be housed with the flushing tank in a single, portable tank unit. The receptacle head is preferably composed of a clear material to enhance visibility and includes an illuminating device as well as indicators to indicate fluid level in the tanks.

U.S. Pat. No. 4,121,306, issued to Bringman et al. describes a urinal comprising a conical shaped body portion having an opening at its terminal apex, a conduit connected at one end at the apex and having a distally disposed three way valve and a remote reservoir. Also included is a flexible, conical shaped liner having a hose at its terminal apex that frictionally engages the terminal apex of the body portion, a sample container and means for connecting the sample container to the valve.

U.S. Pat. No. 4,020,843 issued to Kanall discloses a male external urinary catheter having a sheath member through which a penis is inserted, a platform upon which the penis rests having drainage openings to a lower well compartment with a funnel member draining the lower well compartment to a drainage tube.

U.S. Pat. No. 5,946,742 issued to Parker describes a urine reservoir for a truck allowing a trucker to utilize the urine reservoir while underway and/or without having to detour from a highway while traveling, thereby saving precious travel time and greatly increasing the efficiency of the trucker. The urine reservoir includes a holding tank with a fill system that includes a fill tube with an in-line carbonatious filter that helps eliminate foul odors from entering into the truck cab. The holding tank is positioned and mounted on the truck for quick and easy removal by use of wing nuts and a quick release fill tube disconnecting member. The level of the holding tank is monitored by a float mechanism that audibly and/or visually indicates to the trucker when the urine holding tank should be emptied. The holding tank also includes a deodorant dispensing device that either automatically or manually releases deodorant into an interior of the holding tank helping to prevent odors from emanating from the holding tank.

U.S. Pat. No. 5,655,229 issued to Horn discloses a portable urinal device for bedside and travel use including a urine collection funnel for collecting a urine stream expelled by a user having a substantially conically shaped spout with a wide open inboard end, a narrow open outboard end, an intermediate tapered portion therebetween, and a flow passage extended between the ends and through the intermediate portion; a urine collection bottle having an open mouth; and a urine transfer hose having an upper proximal end removably secured to the outboard end of the urine collection funnel and a lower distal end disposed within the mouth of the bottle for transferring the urine stream from the urine collection funnel to the urine collection bottle.

U.S. Pat. No. 5,848,443 issued to Waugh describes an automobile urinal having a portable elevated flushing solution container, a portable bowl, (which when in use is positioned in the seat) and a portable disposable collecting bladder. The flushing solution container and the disposable collecting bladder are separately connected to the bowl by valved tubing.

U.S. Pat. No. 5,852,830 issued to Horn discloses a portable urinal device for bedside and travel use that includes a flexible collapsible bag having a top face. At least one perforation is formed in the top face of the bag for allowing a user to urinate in the bag. Next provided is a pair of lips integrally coupled to side edges of the top face of the bag and extended upwardly therefrom. The lips have a coupling mechanism thereon for allowing a user to selectively preclude access to the top face and further prevent the leaking of urine from the slits.

While other variations exist, the above-described designs for portable urinals and related receptacles are typical of those encountered in the prior art. It is an objective of the present invention to provide a urinal for use in long-haul trucks, particularly those that have a sleeper compartment. It is a further objective to provide a urinal that is suitable for sanitary use by both males and females. It is a still further objective of the invention to provide for removable, disposable covers for the urine receptacle for female use. It is another objective of the invention to provide a urinal system with a reservoir that is easily emptied without danger of spillage. It is still another objective of the invention to provide a urine receptacle that will control the splashing of urine upon entry. It is yet another objective of the invention that the system be easily installable in a variety of truck applications with minimal modification of the trucks. It is still another objective of the invention to provide a means to deodorize the urinal system. It is a final objective of the invention to provide the above-described capabilities in an inexpensive and durable device that is capable of extended use and that may be easily repaired and maintained.

While some of the objectives of the present invention are disclosed in the prior art, none of the inventions found include all of the requirements identified.

### SUMMARY OF THE INVENTION

The present invention addresses all of the deficiencies of prior art portable urinal inventions and satisfies all of the objectives described above. A truck mounted urinal system, meeting the above-described objectives can be fabricated from the following components.

A urine receptacle is provided. The receptacle has an open top, at least one surrounding wall descending from the top, a bottom sealed to the surrounding wall and an outlet opening penetrating the bottom. A transfer hose is provided. The transfer hose has an outer diameter, a first end and a second end and is sealed to the outlet opening at its first end. A urine reservoir is provided. The reservoir has an inlet opening at an upper end thereof, at least one surrounding wall descending from the upper end and a base sealed to the surrounding wall. The inlet opening is removably sealed to the transfer hose at its second end. Means are provided for emptying the reservoir while minimizing leakage of urine from either the reservoir or the transfer hose.

In a variant of the invention, the means for emptying the reservoir while minimizing leakage of urine from either the reservoir or the transfer hose includes a shutoff valve. The shutoff valve is mounted at a first predetermined distance from the second end of the transfer hose. A receiving sleeve is provided. The receiving sleeve extends upwardly from the inlet opening for a second predetermined distance. The second predetermined distance is slightly less than the first predetermined distance. The receiving sleeve has an upper end, a lower end and an inner diameter and is sized, shaped and disposed to fit frictionally about the outer diameter of the transfer hose. A support ledge is provided. The support ledge extends inwardly from the inner diameter of the receiving sleeve at its lower end to the inlet opening. The support ledge is sized, shaped and disposed to seal against the second end of the transfer hose while permitting urine to flow from the transfer hose through the inlet opening.

When the reservoir has been filled to a point where the volume of urine exceeds the capacity of the reservoir and extends upwardly into the transfer hose, the shutoff valve is closed and the transfer hose is withdrawn from the receiving sleeve, the volume of urine will only partially fill the receiving sleeve, permitting emptying of the reservoir without leakage.

In another variant, the means for emptying the reservoir while minimizing leakage of urine from either of the reservoir and the transfer hose further includes a sealing cap. The sealing cap is sized and shaped to removably attach to and seal the upper end of the receiving sleeve.

In still another variant, the means for emptying the reservoir while minimizing leakage of urine from either of the reservoir and the transfer hose further includes an external screw thread. The external thread is located at the upper end of the receiving sleeve. At least one positioning device is provided. The positioning device is located upon the outer diameter of the transfer hose below the shutoff valve. A compression nut is provided. The compression nut is located on the outer diameter of the transfer hose below the shutoff valve and above the positioning device. The compression nut has an internal thread sized and shaped to threadedly engage the external screw thread. The compression nut has a closed upper end, a open lower end, and an orifice penetrating the closed upper end. The orifice is sized to fit slidably about the outer diameter of the transfer hose while causing an inner surface of the closed upper end to bear against the positioning device.

When the second end of the transfer hose is located against the support ledge and the compression nut is tightened on the external threads of the receiving sleeve while bearing against the positioning device, the second end of the transfer hose will be urged sealably against the support ledge.

In yet another variant of the invention, the system further includes an emptying port. The emptying port includes an outlet orifice that has a raised base and penetrates an upper surface of the reservoir. A pouring spout is provided. The pouring spout extends upwardly from the outlet orifice. A surrounding external thread is provided. The surrounding thread is located on the raised base of the outlet orifice. A screw-on cap is provided. The screw-on cap has a closed end, a surrounding side wall descending therefrom, and an internal thread. The screw-on cap is sized and shaped to enclose the pouring spout and outlet orifice and to threadedly engage the surrounding external thread. When the screw-on cap is removed from the raised base of the outlet orifice, the contents of the reservoir may be poured out through the pouring spout.

In another variant, the raised base of the outlet orifice further includes at least one opening between the surrounding external thread and the pouring spout to permit any urine present on either of an exterior surface of the spout and an interior surface of the screw-on cap to drain back into the reservoir.

In still another variant, the system further includes means for determining a level of contents of the reservoir.

In a further variant, the means for determining the level of the contents of the reservoir comprises a reservoir formed of either of translucent and transparent material.

In still a further variant of the invention, the means for determining the level of the contents of the reservoir comprises a floatation sensor electrically connected to either a remote gauge or an indicator light.

In yet another variant, the system further includes a deodorant dispensing system attached to the reservoir and capable of injecting a deodorant into the reservoir when activated.

In still another variant, the reservoir is attached to a truck body with a quickly releasable mounting. The mounting is operable without the use of tools.

In a further variant, the urine receptacle further includes a quickly releasable lid. The lid is attachable to an outer surface of the receptacle.

In still a further variant, the urine receptacle further includes replaceable liners. The liners are attachable to the open top of the receptacle.

In yet a further variant, the urine receptacle further includes at least one interior vane. The interior vane is attached to an inner surface of the surrounding wall of the receptacle and serves to prevent splashing of urine is introduced into the receptacle.

In another variant the urine receptacle further includes a valve. The valve controls a flow of urine into the outlet opening and is openable by pulling the urine receptacle away from the first end of the transfer hose and closable by pushing the urine receptacle toward the first end of the transfer hose.

In a final variant, the transfer hose includes a telescoping section adjacent its first end the telescoping section permits the urine receptacle to pivot about the transfer hose.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention installed in the sleeping compartment of a truck;

FIG. 2A is a perspective view of the urine reservoir of the FIG. 1 embodiment;

FIG. 2B is a detailed, cross-sectional view of the inlet opening and transfer hose and shutoff valve of the FIG. 2A reservoir illustrating the flow of urine with the valve in the open position;

FIG. 2C is a detailed, cross-sectional view of the inlet opening and transfer hose and shutoff valve of the FIG. 2A reservoir illustrating the level of urine in the inlet opening with the valve in the closed position;

FIG. 3 is a perspective view of the inlet opening of the urine reservoir and sealing cap;

FIG. 4 is a perspective view of the inlet opening of the urine reservoir, transfer hose, positioning device and compression nut;

FIG. 5 is a perspective view of urine reservoir illustrating an emptying port;

FIG. 6 is a detailed, cross-sectional view of the FIG. 5 emptying port taken along the line 6-6;

FIG. 7 is a perspective view of urine reservoir illustrating a visual gauge means for determining a level of contents of the reservoir;

FIG. 8 is a perspective view of urine reservoir illustrating an electrical floatoperated gauge means for determining a level of contents of the reservoir;

FIG. 9 is a side elevational view of the reservoir illustrating a deodorant dispensing system attached to the reservoir;

FIG. 10 is a perspective view of a quickly releasable mounting for the reservoir;

FIG. 11 is a perspective view of the urine receptacle of the FIG. 1 embodiment illustrating a lid attached to an outer surface of the receptacle;

FIG. 12 is a perspective view of the urine receptacle illustrating a replaceable liner attachable to the open top of the receptacle;

FIG. 13 is a perspective view of the urine receptacle illustrating an interior vane attached to an inner surface of the surrounding wall of the receptacle serving to prevent splashing of urine introduced into the receptacle;

FIG. 14 is a perspective view of the urine receptacle illustrating a valve in a closed position for controlling the flow of urine into the transfer hose; and

FIG. 15 is a perspective view of the urine receptacle illustrating a valve in an open position for controlling the flow of urine into the transfer hose.

FIG. 16 is a perspective view of the urine receptacle illustrating a telescoping section in a collapsed position for pivoting the urine receptacle about the transfer hose.

FIG. 17 is a perspective view of the urine receptacle illustrating a telescoping section in an extended position for pivoting the urine receptacle about the transfer hose.

### DETAILED DESCRIPTION OF THE PERFERRED EMBODIMENT

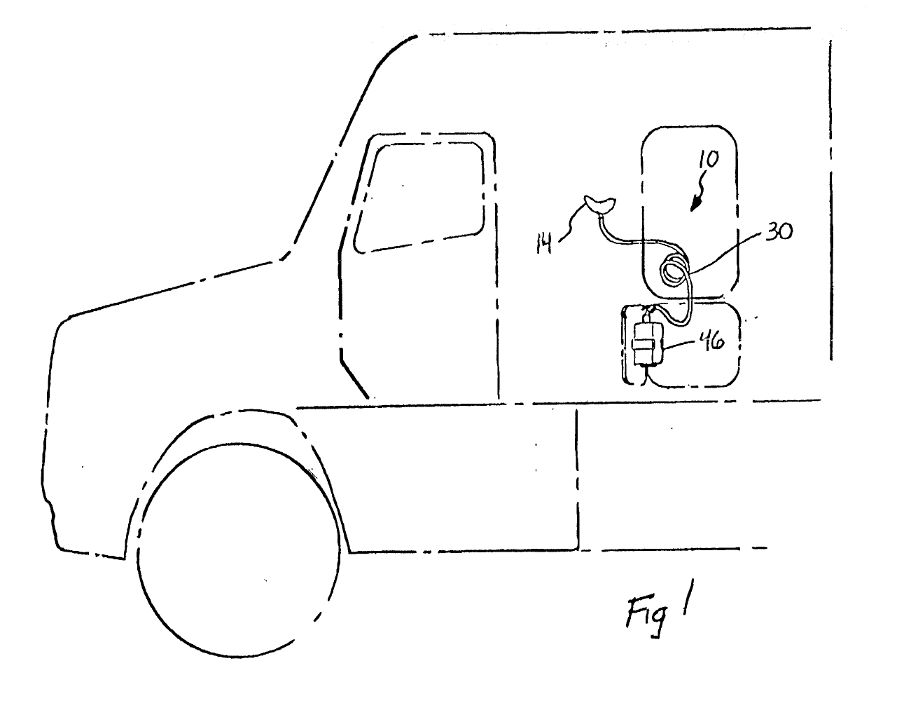

FIGS. 1-15 illustrate a truck mounted urinal system 10, meeting the above-described objectives that can be fabricated from the following components.

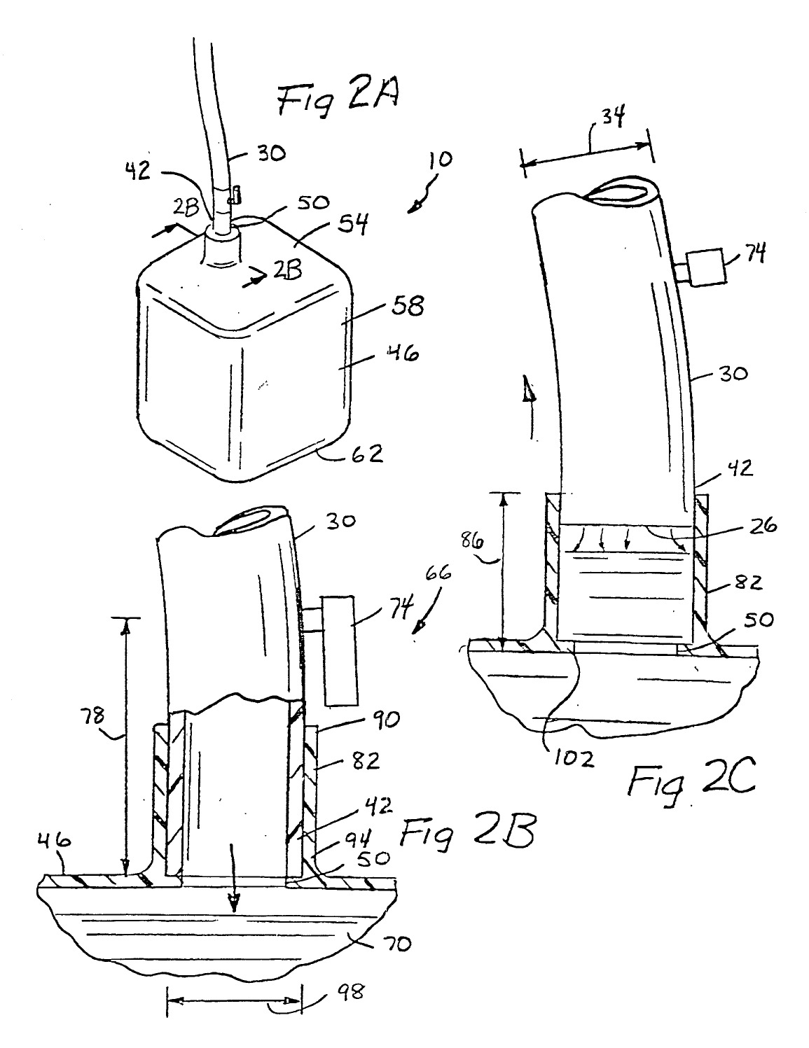

As illustrated in FIGS. 1 and 11-15, a urine receptacle 14 is provided. The receptacle 14 has an open top 18, at least one surrounding wall 22 descending from the top 18, a bottom 24 sealed to the surrounding wall 22 and an outlet opening 26 penetrating the bottom 24. As illustrated in FIGS. 1, 2A-C and 5, a transfer hose 30 is provided. The transfer hose 30 has an outer diameter 34, a first end 38 and a second end 42 and is sealed to the outlet opening 26 at its first end 38. As illustrated in FIGS. 1, 2A-C, 5 and 7, a urine reservoir 46 is provided. The reservoir 46 has an inlet opening 50 at an upper end 54 thereof, at least one surrounding 58 descending from the upper end 54 and a base 62 sealed to the surrounding wall 58. The inlet opening 50 is removably sealed to the transfer hose 30 at its second end 42. As illustrated in FIGS. 5-6, means 66 are provided for emptying the reservoir 46 while minimizing leakage of urine 70 from either the reservoir 46 or the transfer hose 30.

In a variant of the invention, as illustrated in FIGS. 2A-C, the means 66 for emptying the reservoir 46 while minimizing leakage of urine 70 from either the reservoir 46 or the transfer hose 30 includes a shutoff valve 74. The shutoff valve 74 is mounted at a first predetermined distance 78 from the second end 42 of the transfer hose 30. A receiving sleeve 82 is provided. The receiving sleeve 82 extends upwardly from the inlet opening 50 for a second predetermined distance 86. The second predetermined distance 86 is slightly less than the first predetermined distance 78. The receiving sleeve 82 has an upper end 90, a lower end 94 and an inner diameter 98 and is sized, shaped and disposed to fit frictionally about the outer diameter 34 of the transfer hose 30. A support ledge 102 is provided. The support ledge 102 extends inwardly from the inner diameter 98 of the receiving sleeve 82 at its lower end 94 to the inlet opening 50. The support ledge 102 is sized, shaped and disposed to seal against the second end 42 of the transfer hose 30 while permitting urine 70 to flow from the transfer hose 30 through the inlet opening 50.

When the reservoir 46 has been filled to a point where the volume of urine 70 exceeds the capacity of the reservoir 46 and extends upwardly into the transfer hose 30, the shutoff valve 74 is closed and the transfer hose 30 is withdrawn from the receiving sleeve 82, the volume of urine 70 will only partially fill the receiving sleeve 82, permitting emptying of the reservoir 46 without leakage.

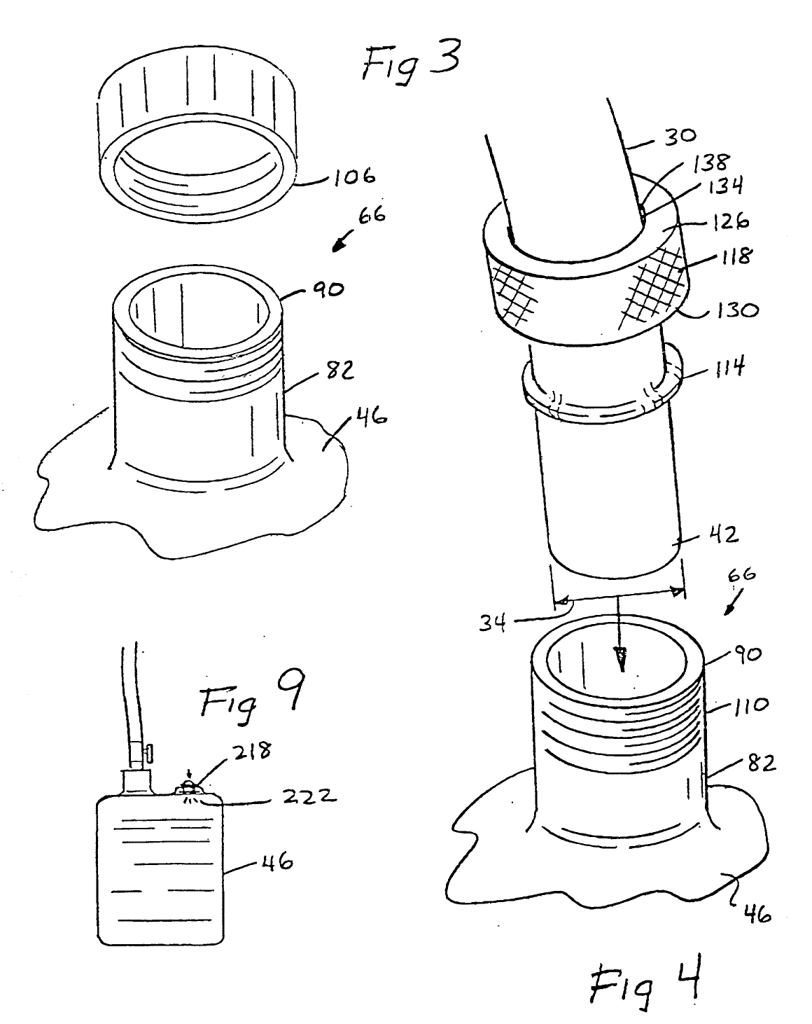

In another variant, as illustrated in FIG. 3, the means 66 for emptying the reservoir 46 while minimizing leakage of urine 70 from either of the reservoir 46 and the transfer hose 30 further includes a sealing cap 106. The sealing cap 106 is sized and shaped to removably attach to and seal the upper end 90 of the receiving sleeve 82.

In still another variant, as illustrated in FIG. 4, the means 66 for emptying the reservoir 46 while minimizing leakage of urine 70 from either of the reservoir 46 and the transfer hose 30 further includes an external screw thread 110. The external thread 110 is located at the upper end 90 of the receiving sleeve 82. At least one positioning device 114 is provided. The positioning device 114 is located upon the outer diameter 34 of the transfer hose 30 below the shutoff valve 74. A compression nut 118 is provided. The compression nut 118 is located on the outer diameter 34 of the transfer hose 30 below the shutoff valve 74 and above the positioning device 114. The compression nut 118 has an internal thread 122 (not shown) sized and shaped to threadedly engage the external screw thread 110. The compression nut 118 has a closed upper end 126, a open lower end 130, and an orifice 134 penetrating the closed upper end 126. The orifice 134 is sized to fit slidably about the outer diameter 34 of the transfer hose 30 while causing an inner surface 138 of the closed upper end 126 to bear against the positioning device 114.

When the second end 42 of the transfer hose 30 is located against the support ledge 102 and the compression nut 118 is tightened on the external threads 110 of the receiving sleeve 82 while bearing against the positioning device 114, the second end 42 of the transfer hose 30 will be urged sealably against the support ledge 102.

In yet another variant of the invention, as illustrated in FIGS. 5 and 6, the system 10 further includes an emptying port 142. The emptying port 142 includes an outlet orifice 146 that has a raised base 150 and penetrates an upper surface 154 of the reservoir 46. A pouring spout 158 is provided. The pouring spout 158 extends upwardly from the outlet orifice 146. A surrounding external thread 162 is provided. The surrounding thread 162 is located on the raised base 150 of the outlet orifice 146. A screw-on cap 166 is provided. The screw-on cap 166 has a closed end 170, a surrounding side wall 174 descending therefrom, and an internal thread 178. The screw-on cap 166 is sized and shaped to enclose the pouring spout 158 and outlet orifice 146 and to threadedly engage the surrounding external thread 162. When the screw-on cap 166 is removed from the raised base 150 of the outlet orifice 146, the contents of the reservoir 46 may be poured out through the pouring spout 158.

In another variant, as illustrated in FIGS. 5 and 6, the raised base 150 of the outlet orifice 146 further includes at least one opening 182 between the surrounding external thread 162 and the pouring spout 158 to permit any urine 70 present on either of an exterior surface 186 of the spout 158 and an interior surface 190 of the screw-on cap 166 to drain back into the reservoir 46.

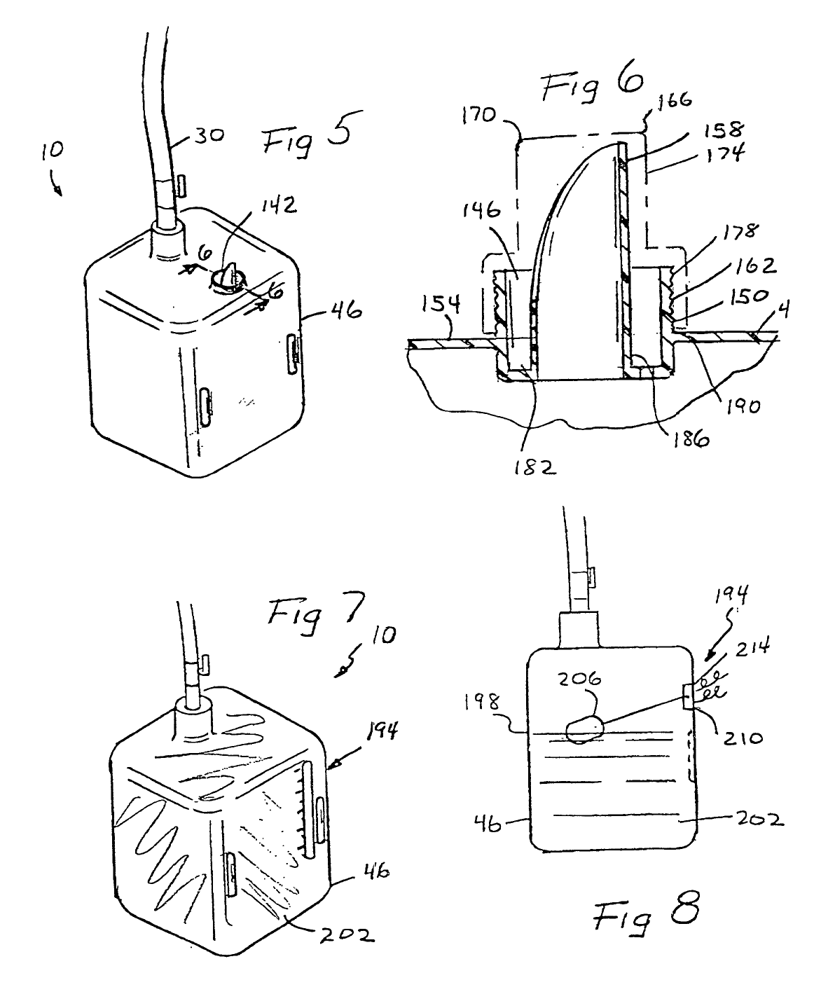

In still another variant, as illustrated in FIGS. 7 and 8, the system 10 further includes means 194 for determining a level 198 of contents 202 of the reservoir 46.

In a further variant, as illustrated in FIG. 7, the means 194 for determining the level 198 of the contents 202 of the reservoir 46 comprises a reservoir 46 formed of either of translucent and transparent material.

In still a further variant of the invention, as illustrated in FIG. 8,the means 194 for determining the level 198 of the contents 202 of the reservoir 46 comprises a floatation sensor 206 electrically connected to either a remote gauge 210 or an indicator light 214.

In yet another variant, as illustrated in FIG. 9, the system 10 further includes a deodorant dispensing system 218 attached to the reservoir 46 and capable of injecting a deodorant 222 into the reservoir 46 when activated.

In still another variant, as illustrated in FIG. 10, the reservoir 46 is attached to a truck body 226 with a quickly releasable mounting 230, the mounting 230 is operable without the use of tools.

In a further variant, as illustrated in FIG. 11, the urine receptacle 14 further includes a quickly releasable lid 234. The lid 234 is attachable to an outer surface 238 of the receptacle 14.

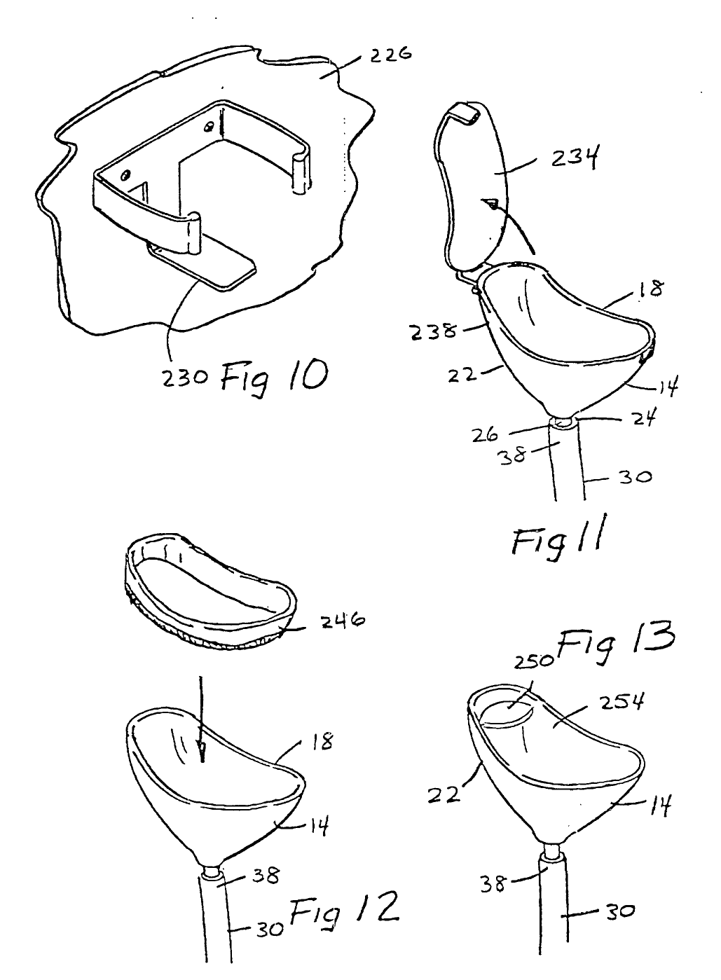

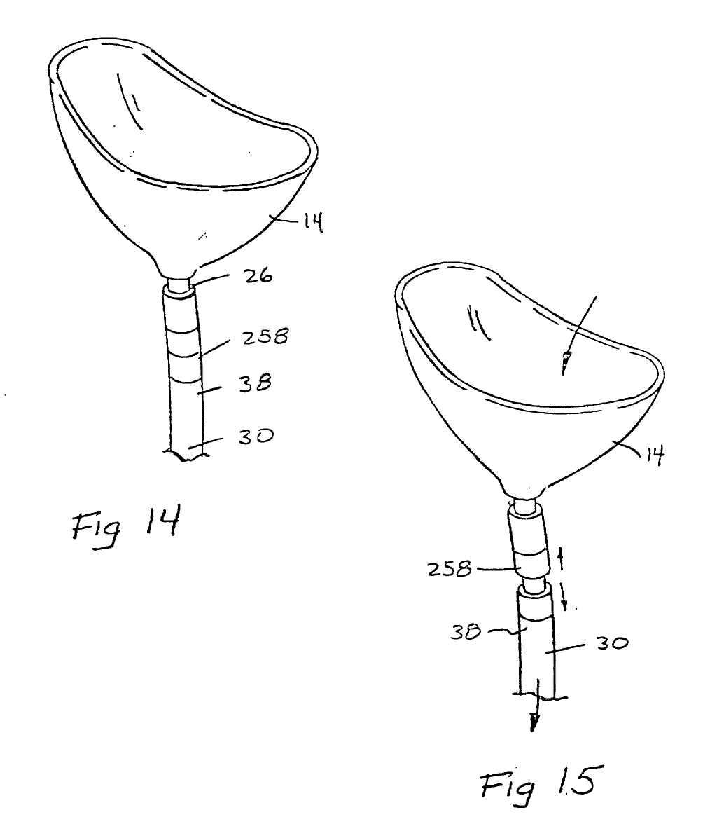

In still a further variant, as illustrated in FIG. 12, the urine receptacle 14 further includes replaceable liners 246. The liners 246 are attachable to the open top 18 of the receptacle 14.

In a final variant, as illustrated in FIG. 13, the urine receptacle 14 further includes at least one interior vane 250. The interior vane 250 is attached to an inner surface 254 of the surrounding wall 22 of the receptacle 14 and serves to prevent splashing of urine 70 introduced into the receptacle 14.

In another variant, as illustrated in FIGS. 14 and 15, the urine receptacle 14 further includes a valve 258. The valve 258 controls a flow of urine into the outlet opening 26 and is openable by pulling the urine receptacle 14 away from the first end 38 of the transfer hose 30 and closable by pushing the urine receptacle 14 toward the first end 38 of the transfer hose 30.

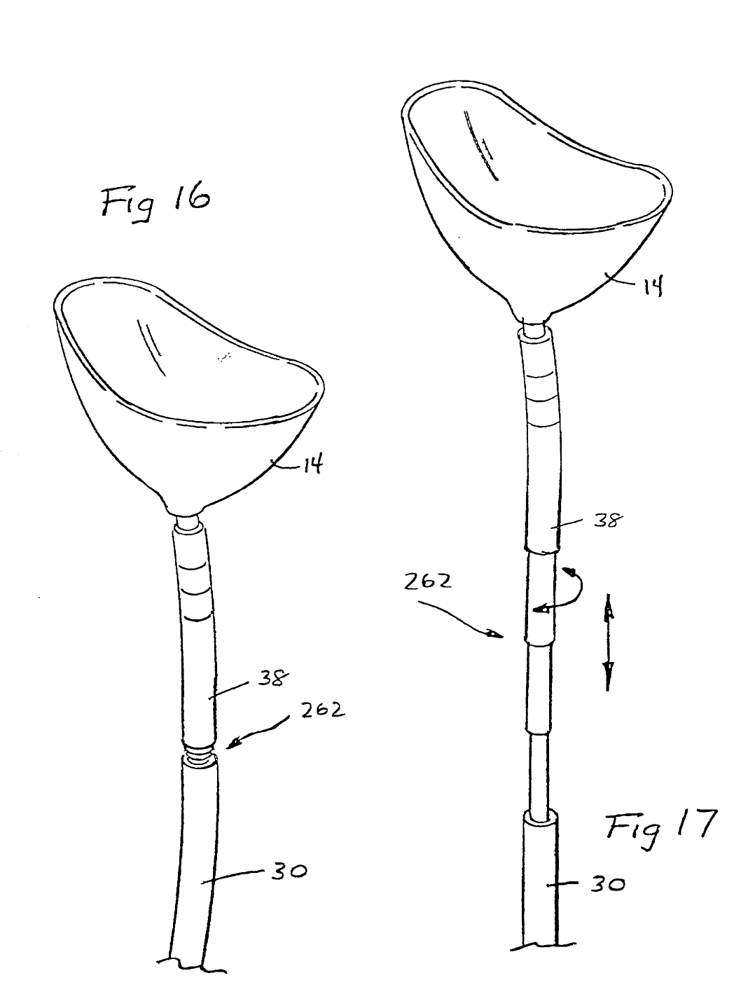

In a final variant, as illustrated in FIGS. 16 and 17, the transfer hose 30 includes a telescoping section 262 adjacent its first end 38. The telescoping section 262 permits the urine receptacle 14 to pivot about the transfer hose 30.

The truck mounted urinal system 10 has been described with reference to particular embodiments. Other modifications and enhancements can be made without departing from the spirit and scope of the claims that follow.

1. A truck mounted urinal system, comprising:
a urine receptacle, said receptacle having an open top, at least one surrounding wall descending from said top, a bottom sealed to said surrounding wall and an outlet opening penetrating said bottom;
a transfer hose, said transfer hose having an outer diameter, a first end and a second end and being sealed to said outlet opening at its first end;
a urine reservoir, said reservoir having an inlet opening at an upper end thereof, at least one surrounding wall descending from said upper end, a base sealed to said surrounding wall, said inlet opening being removably sealed to said transfer hose at its second end; and
means for emptying the reservoir while minimizing leakage of urine from either of the reservoir and the transfer hose.

2. A truck mounted urinal system, as described in claim 1, wherein the means for emptying the reservoir while minimizing leakage of urine from either of the reservoir and the transfer hose further comprises:
a shutoff valve, said shutoff valve being mounted at a first predetermined distance from the second end of the transfer hose;
a receiving sleeve, said receiving sleeve extending upwardly from said inlet opening for a second predetermined distance, said second predetermined distance being slightly less than said first predetermined distance;
said receiving sleeve having an upper end, a lower end and an inner diameter and being sized, shaped and disposed to fit frictionally about the outer diameter of said transfer hose;
a support ledge, said support ledge extending inwardly from the inner diameter of said receiving sleeve at its lower end to said inlet opening;
said support ledge being sized, shaped and disposed to seal against the second end of the transfer hose while permitting urine to flow from the transfer hose through said inlet opening; and
whereby, when the reservoir has been filled to a point where the volume of urine exceeds the capacity of the reservoir and extends upwardly into the transfer hose, the shutoff valve is closed and the transfer hose is withdrawn from the receiving sleeve the volume of urine will only partially fill the receiving sleeve, permitting emptying of the reservoir without leakage.

3. A truck mounted urinal system, as described in claim 2, wherein the means for emptying the reservoir while minimizing leakage of urine from either of the reservoir and the transfer hose further comprises:
a sealing cap, said sealing cap being sized and shaped to removably attach to and seal the upper end of said receiving sleeve.

4. A truck mounted urinal system, as described in claim 2, wherein the means for emptying the reservoir while minimizing leakage of urine from either of the reservoir and the transfer hose further comprises:
an external screw thread, said external thread being disposed at the upper end of said receiving sleeve;
at least one positioning device, said positioning device being disposed upon the outer diameter of said transfer hose below said shutoff valve;
a compression nut, said compression nut being disposed upon the outer diameter of said transfer hose below said shutoff valve and above said positioning device;
said compression nut having an internal thread sized and shaped to threadedly engage said external screw thread and having a closed upper end, a open lower end, and an orifice penetrating said closed upper end, said orifice sized to fit slidably about the outer diameter of said transfer hose while causing an inner surface of said closed upper end to bear against said positioning device; and
whereby, when the second end of the transfer hose is disposed against the support ledge and the compression nut is tightened on the external threads of the receiving sleeve while bearing against the positioning device, the second end of the transfer hose will be urged sealably against the support ledge.

5. A truck mounted urinal system, as described in claim 1, further comprising:
an emptying port, said emptying port comprising:
an outlet orifice, said outlet orifice having a raised base and penetrating an upper surface of said reservoir;
a pouring spout, said pouring spout extending upwardly from said outlet orifice;
a surrounding external thread, said surrounding thread disposed upon the raised base of said outlet orifice;
a screw-on cap, said screw-on cap having a closed end, a surrounding side wall descending therefrom, and an internal thread;
said screw-on cap being sized and shaped to enclose said pouring spout and outlet orifice and to threadedly engage said surrounding external thread; and
whereby when the screw-on cap is removed from the raised base of the outlet orifice, the contents of the reservoir may be poured out through the pouring spout.

6. A truck mounted urinal system, as described in claim 5, wherein the raised base of the outlet orifice further includes at least one opening between the surrounding external thread and the pouring spout to permit any urine present on either of an exterior surface of the spout and an interior surface of the screw-on cap to drain back into the reservoir.

7. A truck mounted urinal system, as described in claim 1, further comprising means for determining a level of contents of the reservoir.

8. A truck mounted urinal system, as described in claim 7, wherein the means for determining the level of the contents of the reservoir comprises a reservoir formed of either of translucent and transparent material.

9. A truck mounted urinal system, as described in claim 7, wherein the means for determining the level of the contents of the reservoir comprises a floatation sensor electrically connected to either of a remote gauge and indicator light.

10. A truck mounted urinal system, as described in claim 1, further comprising a deodorant dispensing system attached to the reservoir and capable of injecting a deodorant into the reservoir when activated.

11. A truck mounted urinal system, as described in claim 1, wherein the reservoir is attached to a truck body with a quickly releasable mounting, said mounting being operable without the use of tools.

12. A truck mounted urinal system, as described in claim 1, wherein the urine receptacle further comprises a quickly releasable lid, said lid being attachable to an outer surface of the receptacle.

13. A truck mounted urinal system, as described in claim 1, wherein the urine receptacle further comprises replaceable liners, said liners being attachable to the open top of the receptacle.

14. A truck mounted urinal system, as described in claim 1, wherein the urine receptacle further comprises at least one interior vane, said interior vane being attached to an inner surface of the surrounding wall of the receptacle and serving to prevent splashing of urine being introduced into the receptacle.

15. A truck mounted urinal system, as described in claim 1, wherein the urine receptacle further comprises a valve, said valve controlling a flow of urine into the outlet opening and being openable by pulling the urine receptacle away from the first end of the transfer hose and closable by pushing the urine receptacle toward the first end of the transfer hose.

16. A truck mounted urinal system, as described in claim 1, wherein the transfer hose further comprises a telescoping section adjacent its first end, said telescoping section permitting the urine receptacle to pivot about said transfer hose.
